(19) United States
(12) Patent Application Publication
(10) Pub. No.: US 2002/0184487 A1
(43) Pub. Date: Dec. 5, 2002

(54) System and method for distributing security processing functions for network applications

(76) Inventors: Michael J. Badamo, Rockville, MD (US); David G. Barger, Darnestown, MD (US); Suresh Iyer, Germantown, MD (US); Christopher C. Skiscim, Dickerson, MD (US); David Sonoda, Rockville, MD (US)

Correspondence Address: MCGLEW & TUTTLE, PC, SCARBOROUGH STATION, SCARBOROUGH, NY, 10510, US

(21) Appl. No.: 09/816,883

(22) Filed: Mar. 23, 2001

(51) Int. Cl. H04L 9/00

(52) U.S. Cl. 713/153; 713/201

(57) ABSTRACT

A network gateway device is provided with a network physical interface for receiving and transmitting data and for receiving packets for transmission and forwarding packets from received data. A packet processor is provided that provides for a key exchange and hosts a security association (SA) used for encryption and decryption for communication with a network peer. The packet processor includes an ingress processing security subsystem with a decryption processor for decrypting packets and an egress processing security subsystem for encrypting packets. One or both of the ingress processing security subsystem and the egress processing security subsystem receiving one or both of ingress and egress SAs. The packet processor may include a processor subsystem for handling key exchanges and for distributing SAs to the ingress processing security subsystem and the egress processing security subsystem. As an alternative, the ingress processing security subsystem and the egress processing security subsystem may host a security association (SA) used for encryption and decryption for communication with a network peer. One of the ingress processing security subsystem and the egress processing security subsystem distributes at least one of an ingress and an egress SA to the other of the ingress processing security subsystem and the egress processing security subsystem.

### FIELD OF THE INVENTION

The invention relates generally to network systems and more particularly to communications between network peers with encryption following a security protocol, such as the Internet security protocol for secure communications.

### BACKGROUND OF THE INVENTION

The Internet Security Protocol (IPSec) is a suite of protocols designed to provide security services for the Internet Protocol (IP). Within the IPSec protocol, extensive use is made of mathematical algorithms for strong authentication and strong encryption. These algorithms are computationally intensive and constitute a significant processing overhead on data exchange. Consequently, specialized hardware is often used to accelerate the computations. The full set of authentication and encryption algorithms, as well as protocols supported by IPSec are well specified and can be found, for instance, in The Big Book of IPSec RFCs, Morgan Kaufmann, 2000.

The IPSec protocol suite provides an architecture with three overall pieces. An authentication header (AH) for IP lets communicating parties verify that data was not modified in transit and, depending on the type of key exchange, that it genuinely came from the apparent source. An encapsulating security payload (ESP) format for IP is used that encrypts data to secure it against eavesdropping during transit. A protocol negotiation and key exchange protocol, the Internet Key Exchange (IKE) is used that allows communicating parties to negotiate methods of secure communication. IKE implements specific messages from the Internet Security Association and Key Management (ISAKMP) message set. A security association (SA) is established between peers using IKE. The SA groups together all the things a processing entity at the peer needs to know about the communication with the other entity. This is logically implemented in the form of a Security Association Database. The SA, under the IPSec specifies:

the mode of the authentication algorithm used in the AH and the keys to that authentication algorithm

the ESP encryption algorithm mode and the keys to that encryption algorithm

the presence and size of (or absence of) any cryptographic synchronization to be used in that encryption algorithm

how you authenticate your communications (using what protocol, what encrypting algorithm and what key)

how you make your communications private (again, what algorithm and what key)

how often those keys are to be changed

the authentication algorithm, mode and transform for use in ESP plus the keys to be used by that algorithm

the key lifetimes

the lifetime of the SA itself

the SA source address

a sensitivity level descriptor

The SA provides a security channel to a network peer wherein the peer can be an individual unit, a group another network or network resource. Various different classes of these security channels may be established with SAs. Using IPSec network entities can build secure virtual private networks. Using the ESP a secure virtual private network service called secure tunneling may be provided wherein the original IP packet header is encapsulated within the ESP. A new IP header is added containing the routable address of a security gateway allowing the private, nonroutable IP addresses to be passed through a public network (the Internet), that otherwise wouldn't accept them. With tunneling the original source and destination addresses may be hidden from users on the public network.

The IPSec protocol is operated between two entities in an IP-based network. In order for the entities to securely exchange data, they must

1. Agree on the type of protection to be used. The protection can be data origin authentication, data integrity or data confidentiality, or some combination.

2. For the chosen type of protection, agree on the algorithm(s) each entity will use as well as other parameters. The two entities authenticate one another and establish an ISAKMP Security Association and encryption/decryption key for exchange of shared, secret keys to be used for data exchange. The ISAMKP SA is used for securely passing messages that control the IPSec protocol.

3. For the chosen type of protection, the two entities agree on keying material which will operate within the algorithms to achieve the agreed upon level of security. The negotiation in this step is encrypted using the ISAKMP SA keys (like an IKE SA).

4. The entities apply the chosen type of protection in data exchanges and periodically change the keying material.

Steps 1 through 3 result in a IPSec Security Association (SA), distinct from the ISAKMP SA, between the two entities. These steps are roughly equivalent to the Internet Key Exchange protocol (IKE—Quick Mode,see RFC 2409). IPSec Security Associations are unidirectional. Thus if entity X and entity Y have completed an IKE, then entity X has a security association with entity Y and entity Y has a security association with entityx. These two associations are distinct and each carries a 32-bit number called the Security Parameter Index (SPI) that uniquely identifies the IPSec SA. The SPI is carried with each data packet exchanged between the two entities and allows the receiver to identify the set of previously agreed algorithms and keys.

For example, entity X would place entity Y's SPI in packets destined for entity Y, and vice versa. The recipient typically uses the SPI as an index into a security association database for retrieval of all information related to the SA.

Either according to a time limit, data exchange limit or exhaustion of a sequence number counter, the SA is refreshed with a new set of keying material. If either side wishes to remove an existing SA, they may send a delete notification for the specific SA. In the case when a failure causes an SA to become unreachable, it is particularly advantageous to inform the peer of this failure through a delete notification. This prevents the peer from sending data packets which would need to be discarded because of the lack of an ingress SA. This conserves processing resources at each peer.

By the very nature of the IKE protocol, it must be performed by the same processing function at each entity as it is bound to a particular IP address. The protocol cannot easily be distributed among processing functions within one entity. In high performance network devices, the mathematical algorithms operated to generate keys, perform encryption and authentication in order to populate message fields in the IKE and IPSec messages may be accelerated with special hardware. Alternatively, highly optimized software may be used.

The IKE protocol results in each entity possessing knowledge of the encryption functions and keys destined for its peer and knowledge of the decryption functions and keys for traffic from the peer. This dual set of information is thus available only within the entity's processing function at the termination of an IKE. In the event of a failure of the processing entity, the security associations hosted there are typically allowed to expire. If a spare processing entity assumes the role of the failed entity, new SAs are negotiated between the peers

In deploying IPSec, ingress and egress packets may pass through a security system or subsystem for encryption and decryption. The security system or subsystem is the source of the IKE and thus maintains the SAs (the IKE terminates with the IPSec SA in one place). This can become a significant processing bottleneck as ingress and egress traffic must pass through a single processing function for encryption and decryption, respectively. Often there is an asymmetry between the flows requiring encryption and/or generation of authentication material, and those requiring decryption and/or verification of authentication material. Thus, ingress security traffic can block egress security traffic, and vice-versa. Employing multiple HW accelerators in place boosts throughput. However, the accelerators have both ingress and egress IPSec SAs, so there is still a bottleneck.

### SUMMARY AND OBJECTS OF THE INVENTION

This invention solves this contention problem by distributing the ingress and egress IPSec SecurityAssociations. Separate security subsystems are implemented, both with hardware acceleration support for the cryptographic algorithms.

According to the invention, a network gateway device is provided with a network physical interface for receiving and transmitting data and for receiving packets for transmission and forwarding packets from received data. A packet processor is provided that provides for a key exchange and hosts a security association (SA) used for encryption and decryption for communication with a network peer. The packet processor includes an ingress processing security subsystem with a decryption processor for decrypting packets and an egress processing security subsystem for encrypting packets. One or both of the ingress processing security subsystem and the egress processing security subsystem is provided with one or both of ingress and egress SAs.

The packet processor may include a processor subsystem for handling key exchanges and for distributing SAs to the ingress processing security subsystem and the egress processing security subsystem. As an alternative, the ingress processing security subsystem and the egress processing security subsystem may host a security association (SA) used for encryption and decryption for communication with a network peer. One of the ingress processing security subsystem and the egress processing security subsystem distributes at least one of an ingress and an egress SA to the other of the ingress processing security subsystem and the egress processing security subsystem.

The packet processor may advantageously include an ingress processor system for ingress processing of received packets and an egress processor system for processing packets for transmission. The ingress processor system includes an ingress packet processor and includes the ingress processing security subsystem. The egress processor system includes an egress packet processor and includes the egress processing security subsystem. Interconnections are provided including an interconnection between the ingress processor and the egress processor, an interconnection between the ingress processor and the physical interface and an interconnection between the egress processor and the physical interface.

According to another aspect of the invention, a process is provided for secure communication between network entities. The process includes providing a device with a network interface and physical connection with a packet processing system including an ingress processing subsystem and an egress processing subsystem. A key exchange is made between the network entity and the other network entity. A security association (SA) is hosted based on the key exchange, upon completion of the key exchange. The SA is saved in association with a processing entity of the packet processing system. The SA includes information as to authentication, encryption and changing of keys. Data is extracted or derived from the security association and sent as a security message from a processing entity hosting the security association to one or both of the ingress processing subsystem and the egress processing subsystem to provide a security association at the processing subsystems.

An ingress security subsystem and a separate egress security subsystem are provided. One security subsystem (ingress or egress) or another entity of the security system hosts the IKE and therefore the ISAKMP SAs. The IPSec SA is distributed to the other security subsystem (ingress or egress), or distributed to each of the security subsystems. The IKE operates on one processor, sets up the IPSec SA and retains the ISAKMP (IKE) SA. One (or both) of the IPSec SAs is moved to a security subsystem. Since IPSec SAs are unidirectional, there is no need for them to be on the same security subsystem.

The security subsystem that hosts the IPSec or an IPSec subsystem begins an IKE. The hardware accelerator accelerates the mathematics for the IKE messaging but the IKE state machine is software-based. When an IKE is hosted e.g., on the egress security subsystem, the IKE terminates to provide an ISAKMP SA used for security IPSec control messages, and an IPSec SA used to handle the data traffic between the two peers. In this example the ISAKMP SA stays on the egress security subsystem and the egress IPSec SA is kept on the egress security subsystem. The ingress IPSec SA corresponding to the retained egress IPSec SA is now moved to the ingress security subsystem.

The invention described here alleviates the processing bottleneck wherein ingress and egress flows requiring security services compete for encryption and decryption services. It also maintains fault tolerance by saving the security context that will allow orderly deleting of peer SA's and re-establishment of new SA's. The following are salient features of the design:

1) The security subsystem (ingress or egress) or the IKE subsystem or the IPSec subsystem is responsible for the setup, maintenance and release of ISAKMP and IPSec SAs. An SA created as a result of an IKE, can be performed with hardware acceleration on either the ingress security subsystem or the egress security subsystem. Once the SAs have been established, the IPSec subsystem is not directly involved in the processing of packets—this is performed by the security subsystem via the ingress and egress packet processor interface to the security subsystem.

2) The processing of ingress and egress packets for a given IPSec SA, is performed by a hardware accelerator (e.g., an application specific integrated circuit) exclusively devoted to decryption/authentication of ingress packets and a hardware accelerator exclusively devoted to encryption/generation of authentication of egress packets. Thus, ingress and egress packets do not contend for a single hardware resource.

3) To facilitate #2, when an SA is setup, the security subsystem (ingress or egress) or the IKE subsystem or the IPSec subsystem IPSec subsystem encrypts the SA information using a symmetric block cipher keyed by a service card specific key generated at system initialization. The SA information is then extracted from the hardware accelerator and copied to the other hardware accelerator. If the SA is established on the ingress hardware accelerator, the copy is done to the egress hardware accelerator, and vice-versa.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1A is a schematic drawing of a system using the device according to the invention;

FIG. 1B is a schematic drawing of another system using the device according to the invention;

FIG. 2A is a diagram showing a processing method and system according to the invention;

FIG. 2B is a diagram showing further processing aspects of the processing method shown in FIG. 2A;

FIG. 3 is a diagram showing system components of an embodiment of the device according to the invention;

FIG. 4 is a diagram showing service card architecture according to an embodiment of the invention;

FIG. 5 is a diagram showing service card and control card interaction for two different embodiments of the invention;

FIG. 6 is a diagram showing the context of the security system architecture according to one embodiment of the invention;

FIG. 7A is a flow diagram showing an example of a process according to the invention for secure communication;

FIG. 7B is a flow diagram showing another example of a process according to the invention for secure communication; and

FIG. 7C is a flow diagram showing still another example of a process according to the invention for secure communication; and

FIG. 8 is a diagram showing the context of the security system architecture according to another embodiment of the invention.

### DESCRIPTION OF THE PREFERRED EMBODIMENTS

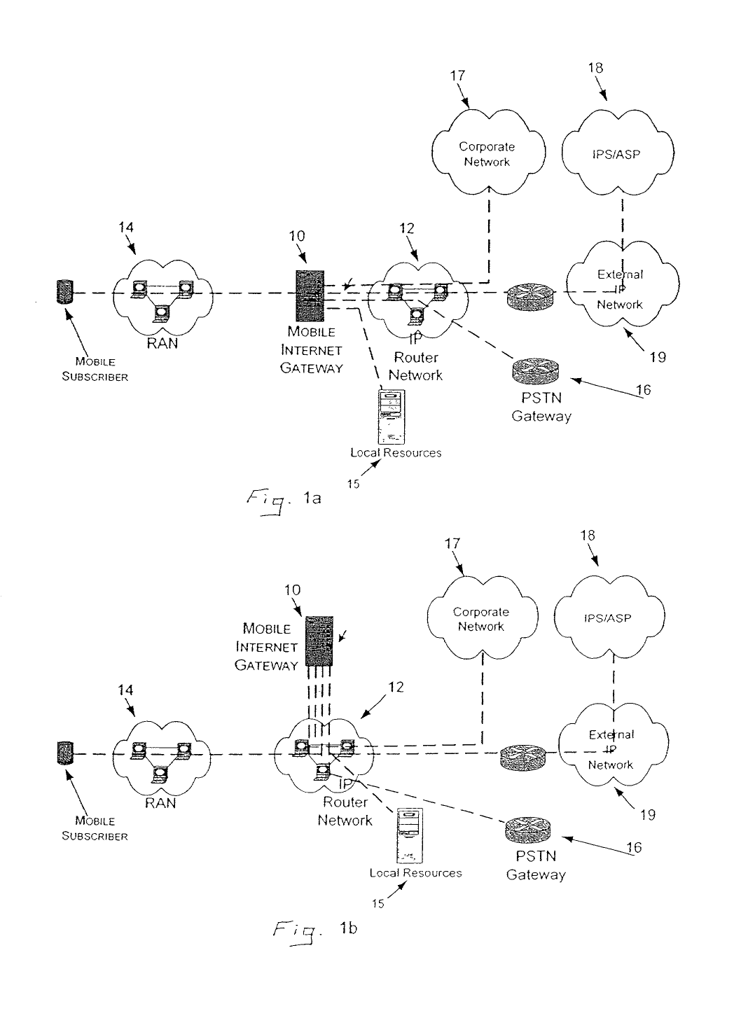

Referring to the drawings in particular, the invention comprises a network infrastructure device or mobile Internet gateway 10 as well as a method of communication using the gateway 10. FIGS. 1A and 1B depict two possible deployments of the invention. The invention can form a separation point between two or more networks, or belong to one or more networks. Gateway 10 handles data traffic to and from mobile subscribers via Radio Access Network (RAN) 14. As shown in FIG. 1A data traffic arriving from, or destined to users on the RAN 14 must use one or more data communications protocols specific to mobile users and specific to the RAN technology. Traffic arriving from, or destined for the IP Router Network (e.g., the Internet) 12 can use a variety of IP-based protocols, sometimes in combination. The architecture of the gateway 10 described here, the Packet Gateway Node (PGN) 10 solves the problem of being able to provide protocol services to the RAN 14 and to the IP Network 12, scale to large numbers of users without significant degradation in performance and provide a highly reliable system. It also provides for management of mobile subscribers (e.g., usage restrictions, policy enforcement) as well as tracking usage for purposes of billing and/or accounting.

The IP router network generally designated 12 may include connections to various different networks. The IP router network 12, for example, may include the Internet and may have connections to external Internet protocol networks 19 which in turn provide connection to Internet service provider/active server pages 18 or which may also provide a connection to a corporate network 17. The IP router network 12 may also provide connections to the public switched telephone network (PSTN) gateway 16 or for example local resources (data storage etc.) 15. The showing of FIGS. 1A and 1B is not meant to be all inclusive. Other networks and network connections of various different protocols may be provided. The PGN 10 may provide communications between one or more of the networks or provide communications between users of the same network.

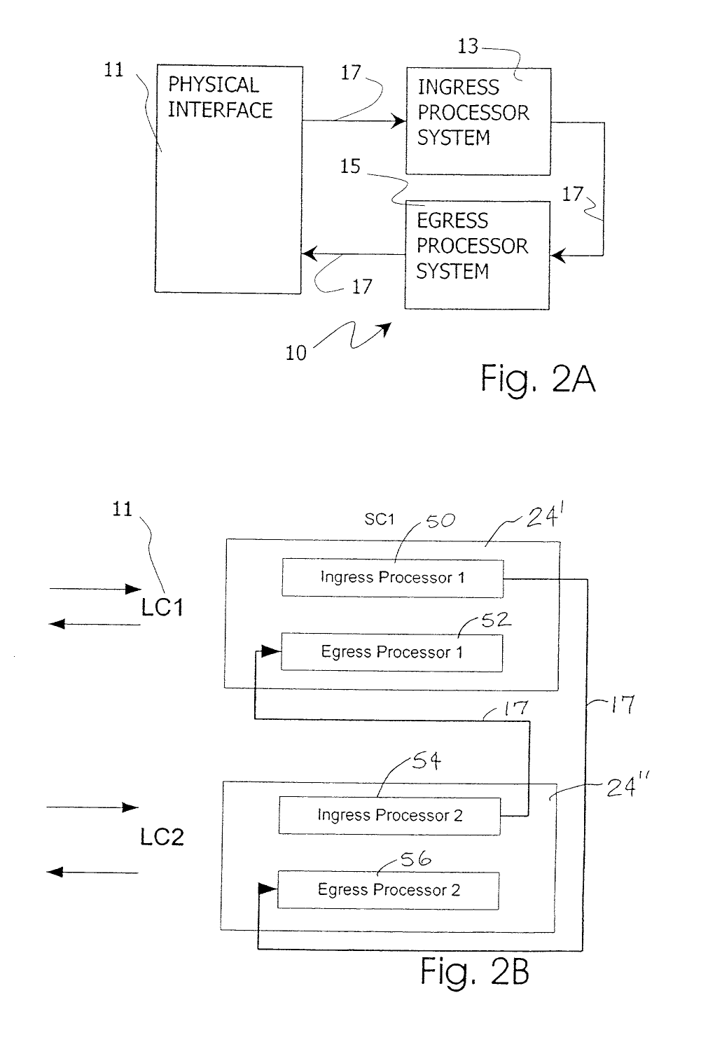

It is often the case that the amount of ingress processing differs from egress processing. FIG. 2A shows an aspect of the device and method of the invention whereby the ingress processing and egress processing are divided among different processing systems. Packets are received at the PGA 10 at physical interface 11 and packets are transmitted from the PGA 10 via the physical interface 11. The physical interface 11 may be provided as one or more line cards 22 as discussed below. An ingress processing system 13 is connected to the physical interface 11 via interconnections 17. The ingress processing system 13 preforms the ingress processing of received packets. This ingress processing of packets includes at least one or more of protocol translation, de-encapsulation, decryption, authentication, point-to-point protocol (PPP) termination and network address translation (NAT). An egress processing system 15 is connected to the physical interface 11 via interconnections 17 and is also connected to the ingress processing system 13 by interconnections 17. The egress processing system 13 preforms the egress processing of received packets to be transmitted. This egress processing of packets includes at least one or more of protocol translation, encapsulation, encryption, generation of authentication data, PPP generation and NAT. The ingress processor 13 and egress processor 15 may be provided as part of a device integrated with the physical interface. Additionally, the ingress processor 13 and egress processor 15 may be provided as part of one or more service cards 24 connected to one or more line cards 22 via the interconnections 17. The processing method and arrangement allows ingress and egress processing to proceed concurrently.

As shown in FIG. 2B one service card 24′ may provide the ingress processing and another service card 24″ may provide the egress processing. The ingress processing or egress processing may be distributed between more than one service card 24. As shown in FIG. 2B a service card 24′ includes ingress processor system 50 and egress processor system 52. Packets are received from a line card LC1 designated 22′ and packets enter the ingress processor 50 where they are processed to produce an end-to-end packets, i.e., tunnels (wherein the original IP packet header is encapsulated) are terminated, Internet protocol security (IPSec) packets are decrypted, Point-to-Point Protocol (PPP) is terminated and NAT or NAT-ALG is performed. The end-to-end packets are then sent to another service card 24″ via interconnections 17. At this other service card 24″ the egress processor system 56 encapsulates and encrypts the end-to-end packets and the packets are then sent to the LC2 designated 22″ for transmission into the network at interface 11.

Each of the processor systems (13 and 15 in the example of FIG. 2A and 50, 52, 54 and 56 in the example of FIG. 2B) preferably are provided with purpose built processors. This allows the processing of special packets, security packets, control packets and simple protocol translation concurrently. This allows the PGA 10 to use a single point of queuing for the device. A packet queue establishes a queue of packets awaiting transmission. This packet queue position in the processing path is the exclusive buffer location for packets between packets entering the device and packet transmission. The packets exit the device or complete processing at a rate of the line established at the physical interface (at the rate of the packet ingress). Each processor system preferably includes a fast path processor subsystem 62 or 64 processing packets at speeds greater than or equal to the rate at which they enter the device. The fast path processor systems 62 and 64 provide protocol translation processing converting packets from one protocol to another protocol. Each processor preferably includes a security processor subsystems 73 and 74 for processing security packets and preferably a control subsystem 70 for control packets and a fast path coprocessor subsystem 68 for special packets. The processor subsystems process concurrently. The device 10 allows context (information related to user traffic) to be virtually segregated from other context. Further, the use of multiple service cards allows context to be physically segregated, if this is required.

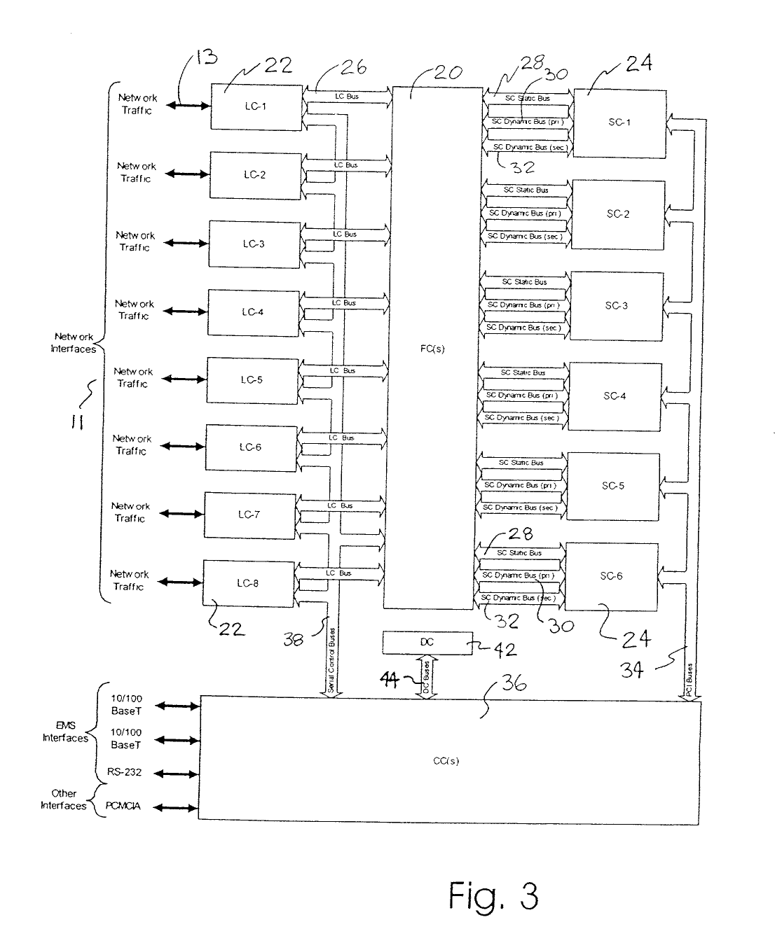

FIG. 3 shows a diagram of an embodiment of the hardware architecture. The system architecture of device 10 divides packet processing from traffic to and from the line cards (LCs) 22 via a switch fabric or fabric card (FC) 20. Processing is performed in service cards (SC) 24. The LCs 22 are each connected to the FC 20 via a LC bus 26 (static LC bus). The SCs 24 are connected by a SC static bus 28, SC dynamic bus (primary) 30 and SC dynamic bus (secondary) 32. A control card (CC) 36 is connected to LCs 24 via serial control bus 38. The CC 36 is connected to SCs 24 via PCI bus 34. A display card (DC) 42 may be connected to the CC 36 via DC buses 44. One or more redundant cards may be provided for any of the cards(modules) described herein. The architecture of the PGN 10 allows all major component types, making up the device 10, to be identical. This allows for N+1 redundancy (N active components, 1 spare), or 1+1 redundancy (1 spare for each active component).

The LCs 22 each provide a network interface 11 for network traffic 13. The LCs 22 handle all media access controller (MAC) and physical layer (Phy) functions for the system. The FC 20 handles inter-card routing of data packets. The SCs 24 each may implement forwarding path and protocol stacks.

Packet manipulation with respect to tunnel termination, encryption, queuing and scheduling takes place on the SC 24. The master of the system is the CC 36. The CC 36 manages the system, and acts as the point of communication with other entities in the network, i.e. the policy servers and the accounting manager. One of the purposes of the control card is to recognize a service card failure and switch in a spare to assume its functions. The service card communicates with the control card via the PCI bus 34. Any service card 24 handling ingress processing (e.g., at 50) can send traffic to any other service card 24 for egress processing (e.g., at 56). Thus, the device can make use of unused capacity that may exist on other service cards 24.

The line cards (LC-x) 22 provide the physical interfaces. The line cards 22 are connected via the bus 38 to the (redundant) switch fabric card(s) (FC). Line card 22s may be provided as two types, intelligent and non-intelligent. An intelligent line card 22 can perform packet classification (up to Layer 3, network layer) whereas the non-intelligent line cards 22 cannot. In the former case, classified packets can be routed, via the FC 20, to any service card 24 (SC) where ingress and egress processing occurs. This routing can be configured statically or can be determined dynamically by the line card 22. Any service card 24 can send traffic requiring ingress processing (e.g. from SC1 24′ to SC2 24″) to any other service card 24 for ingress processing. Line cards 22 with the capability to classify ingress traffic can thus make use of unused capacity on the ingress service cards 24 by changing the routing. This allows for load balancing since the LC 22 can route to the SC 24 with the least loaded ingress processor. In the latter case, the assignment of LCs 22 to SCs 24 is static, but programmable. Redundancy management is also made easier: In the event of failure of a line card 22, a standby spare can be switched in by re-directing the flow through the FC 20. The flexible routing enables any service card 24 or line card 22, in particular a spare service card 24 or line card 22, to assume the role of another service card 24 or line card 22 by only changing the routing through the switch fabric card (FC) 20.

To support scalable performance, the device 10 divides the processing of in-bound protocols (e.g., the ingress path of LC1 22′ through ingress processor 50 as shown in FIG. 2B), the out-bound protocols (e.g., the egress path of LC2 22″ through egress processor 56 as shown in FIG. 2B) protocol control messaging, and the special handling of traffic requiring encryption. Various protocols may be implemented. The Internet protocol (IP) preferably is used at the network layer functioning above the physical/link layer (physical infrastructure, link protocols—PPP, Ethernet, etc.) and below the application layer (interface with user, transport protocols etc.). The device 10 can be used with the IPSec protocol for securing a stream of IP packets. In such a situation, where secure virtual private networks are established the PGN 10 will perform ingress processing including implementing protocol stacks in a software process. On the ingress side this can involve for example de-encapsulating and decrypting, protocol translating, authenticating, PPP terminating and NAT with the output being end-to-end packets. On the egress side, end-to-end packets may be encapsulated, encrypted protocol translated, with authentication data generation, PPP generation and NAT.

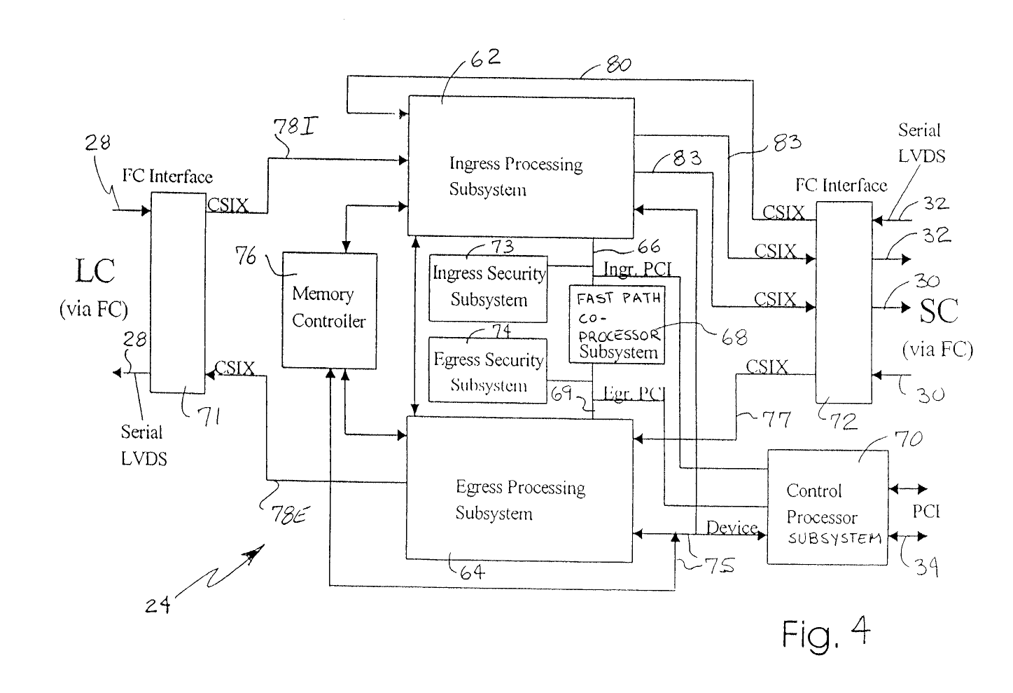

FIG. 4 shows an example of a service card 24 (SC-x). Each SC 24 provides ingress processing with ingress processing subsystem 62 (for fast path processing) and egress processing with physically separate egress processing subsystem 64 (for fast processing). The processing functions of these subsystems 62 and 64 are separate. Each ingress processing system contains a separate bus 66 for special processing and separate components 68, 70 and 73 for special processing. Each egress processing system contains a separate bus 69 for special processing and the separate components 68, 70 and 74 for special processing. The ingress and egress PCI buses 66 and 69 are the central data plane interfaces from the control plane to the data plane. The ingress PCI bus 66 connects the ingress processor 62 and the encryption subsystem or security subsystem 74, fast path co-processor subsystem 68 and control processor system 70. The PCI bus 69 provides similar connections for the egress processing system.

The role of the service cards, such as SC 24′, is to process IP packets. IP packets enter the SC 24′ through the FC interface 20; this is traffic coming, e.g., from LC1 22′. Packets enter the ingress processing subsystem 62 of the ingress processor system 50 via CSIX link 781, where they are classified as subscriber data or control data packets. Control packets are sent up to one of two microprocessors, the control processor 70 or the fast path coprocessor 68. Protocol stacks, implemented in software, process the packets at the control processor 70 or the fast path coprocessor 68. A subscriber data packet is processed by the ingress processing subsystem 62 and or security subsystem 73 to produce an end-to-end packet (i.e. tunnels are terminated, IPSec packets are decrypted). The end-to-end packet is sent to an egress processor (e.g., another SC 24″ via the FC 20). Packets exit the ingress processor through CSIX links 83 and the interface 72 to the FC 20. Packets may also be sent to another ingress processor (via the CSIX link 80 of the particular SC 24). The packets enter the egress processor system via CSIX links 77. This may be by use of another service card (e.g., SC 24″) where all the necessary encapsulation and encryption is performed. The packet is next sent to, e.g., LC2 22″ that must transmit the packet into the network. Protocol stacks running on the control processor and fast path co-processor may also inject a packet into the egress processor for transmission.

Processing resources for ingress and egress can be allocated on different service cards 24 for a given subscriber's traffic to balance the processing load, thus providing a mechanism to maintain high levels of throughput. Typically, a subscriber data session is established on a given SC 24 for ingress and the same, or another SC 24 for egress. Information associated with this session, its context, is maintained or persists on the ingress and egress processor (e.g., of the processing subsystems 62 and 64, the security subsystems 73 and 74). The routing of ingress to ingress (e.g., from SC 24″ via bus 32, FC 20, FC interface 72 and CSIX link 80) permits the traffic to enter via a different LC 22 (because of the nature of the mobile user, such user could have moved and may now be coming in via a different path) and be handled by the ingress processing subsystem SC 24 holding the context (e.g., by Ingress processing subsystem 62 of SC 24′). This eliminates the need to move the context at the price of maintaining context location. For example, the context information may be held and controlled by memory controller 76, which is connected to control subsystem 70 and the processor subsystem 62 and subsystem 64 via device bus 75. Moving context data can be problematic.

The LC static buses 26, and SC static buses 28, interconnect line cards 22 and service cards 24 through the fabric card 20. These connections are established when the control card configures the fabric card 20. SC static bus 28 is connected by interface 71 and CSIX lines 781 and 78E to the ingress processor subsystem 62 and the egress processor subsystem 64 respectively. Connections made between LCs 22 and SCs 24 may be made to be virtually static. The connections may rarely change. Some reasons for connection changes are protection switchover or re-provisioning of hardware. The primary dynamic buses 30 connect the ingress processor of one service card 24 to the egress processor of another service card 24 via the fabric card 20 on a frame-by-frame basis. One or more interfaces 72 and CSIX lines 83, 80 and 77 provide the connection to the busses 30 and 32.

The entire system may be monitored using a display card 42 via display buses 44. The line cards may be monitored via serial control buses 38. The control card 36 may have other output interfaces such as EMS interfaces 48 which can include any one or several of 10/100 base T outputs 43 and serial output 47 and a PCMCIA (or compact flash) output 49.

Th invention solves the security ingress and egress processing contention problem by distributing the ingress and egress security associations. Separate security subsystems 73 and 74 are implemented, both with hardware acceleration support for the cryptographic algorithms.

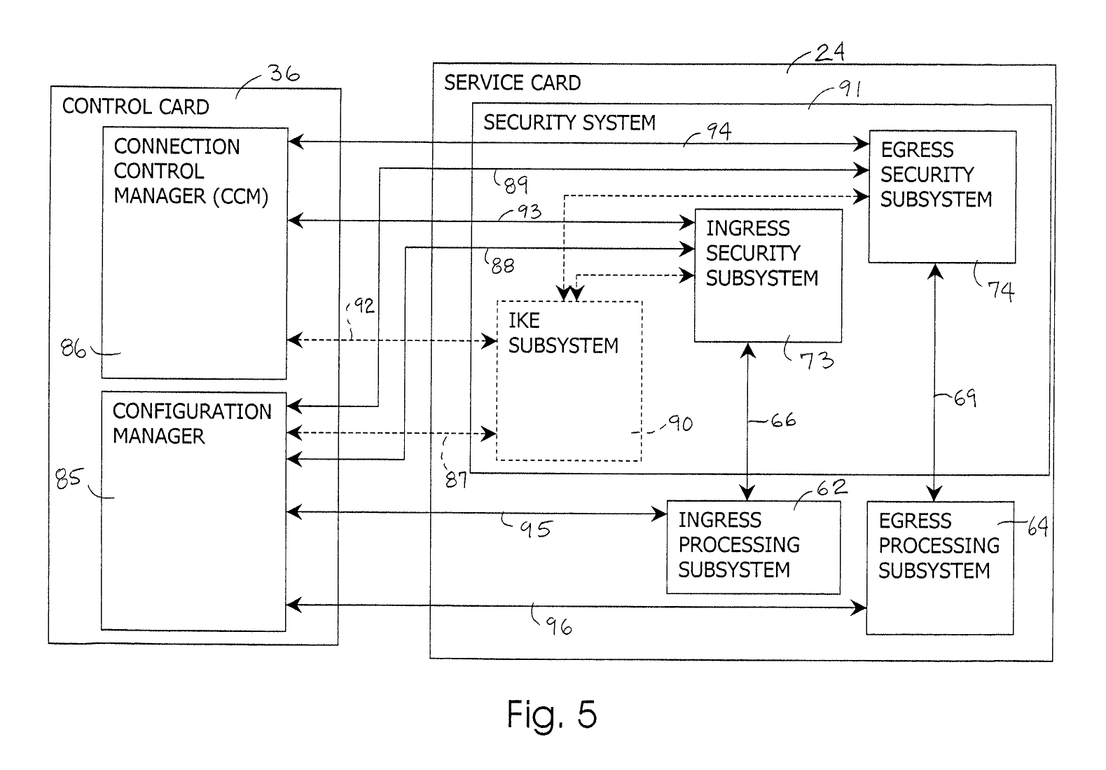

FIG. 5 shows service card 24 and control card 36 interaction. The CC 36 performs configuration via the configuration manager 85. The security elements are shown grouped together as an overall security system 91. The configuration manager is connected to the subsystems 62 and 64 as shown at 95 and 96 and connected to the IKE subsystem 90 (if provided) according to one embodiment at dash line 87 or to the security subsystems at 88 and 89. A connection control manager (CCM) 86 manages ingress and egress data sessions for purposes of billing, determining security policy, and fault detection and recovery. According to one embodiment, when a data session requests security services, the CCM 86 notifies the IKE Subsystem 90 as shown at 92. The IPSec subsystem 90 then performs a key exchange with a peer security gateway as indicated by the requester. The ingress and egress security subsystems 73 and 74 are used to provide cryptographic support in either software or hardware. These subsystems 72 and 73 have an interface 66, 69 with the fast path ingress processor subsystem 62 and the egress processor subsystems 64. The processors 62 and 64 are specialized processors used to rapidly process data packets through the system. In this case, the fast path processors 62 and 64 would be made aware of the security association in order for the appropriate packets to be processed directly through the ingress and egress security subsystems depending on the direction of the traffic. According to another embodiment, one of the two security subsystems 73 and 74 performs a key exchange with a peer security gateway as indicated by the requester after notification by CCM 86 at 93 and 94. The one of the two security subsystems 73 and 74 then distributes the security association to the other of the two security subsystems 73 and 74.

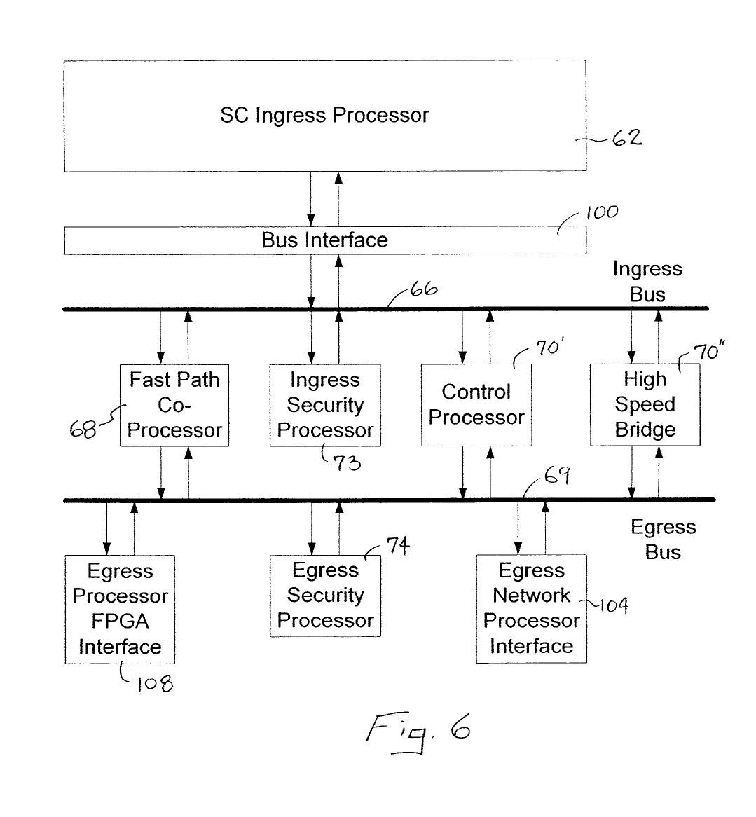

FIG. 6 is a diagram to explain the security processor subsystem architecture according to an embodiment of the invention. The ingress processor 62 is shown (a similar connection is provided from the SC egress processor 64 to via the egress processor FPGA interface 108). An egress network processor interface may also be provided, connected to the egress bus 69. A control processor 70′ and a high speed bridge 70″ (both part of the control processor subsystem 70) provide connections between the busses 66 and 69. When the SC ingress processor 62 receives a data packet, the security policy of this packet is checked using the 5-tuple (Source Address, Source Port, Destination Address, Destination Port, Protocol Type). If IPSec security treatment is required on egress and no security association exists, the SC ingress processor 62 sends a message through the bus interface 100, ingress bus 66 to the Fast Path Co-Processor (FPCP) (a microprocessor) 68 indicating that an SA is to be created with a designated remote peer. The FPCP 68 then initiates an IKE exchange with the designated remote peer. The FPCP uses either the ingress security processor 73 or egress security processor 74 for generating security parameters and cryptographic algorithms. For example, if the ingress security processor 73 is used for cryptographic services (egress security processor 74 could also be used), when the IKE successfully terminates, the resulting pair of SA's reside in the ingress security processor 73. The FPCP 68 then extracts and moves the relevant parameters of the SA to the egress security processor 74 using one of the following three methods.

Establishing a Distributed Security Association—Method 1

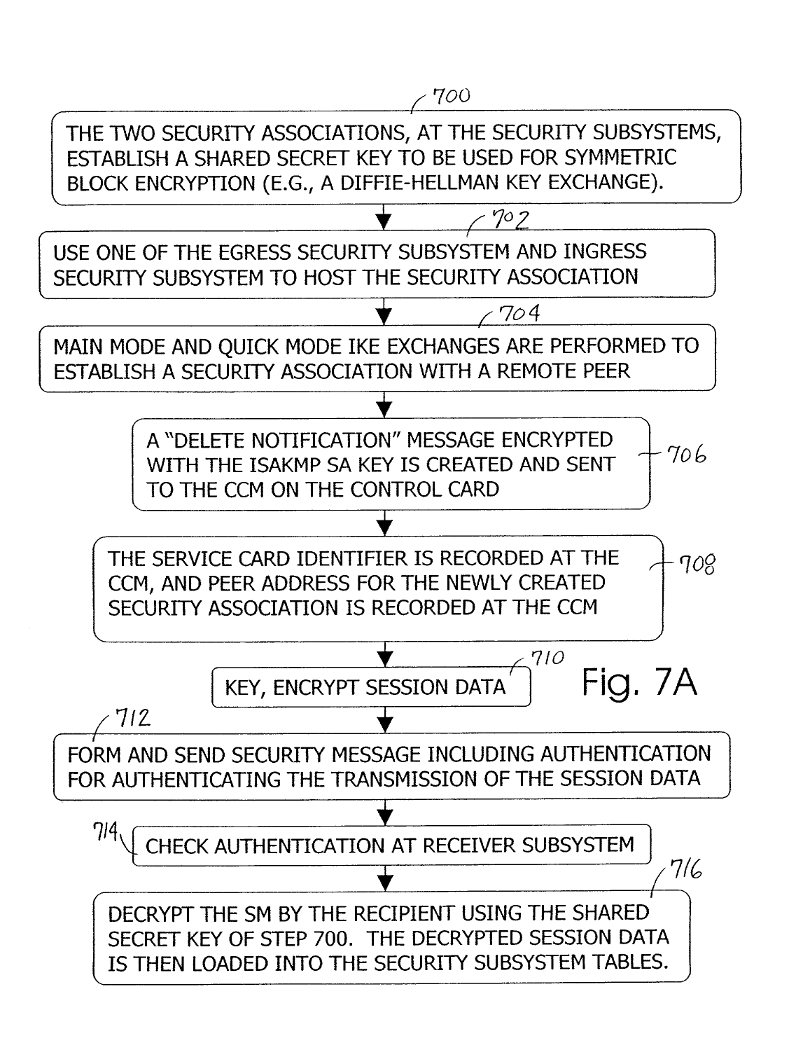

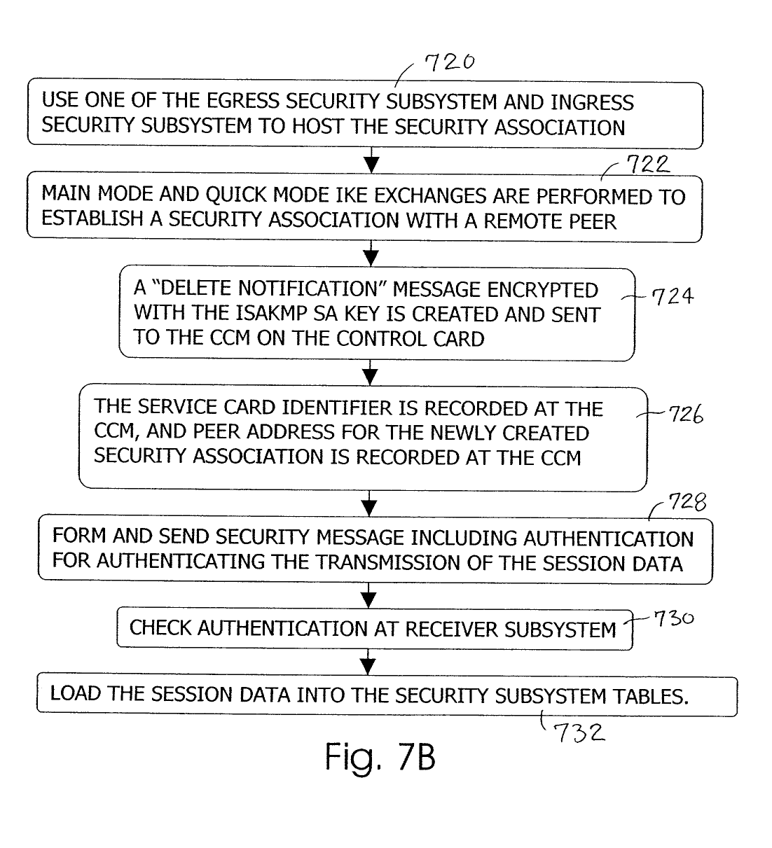

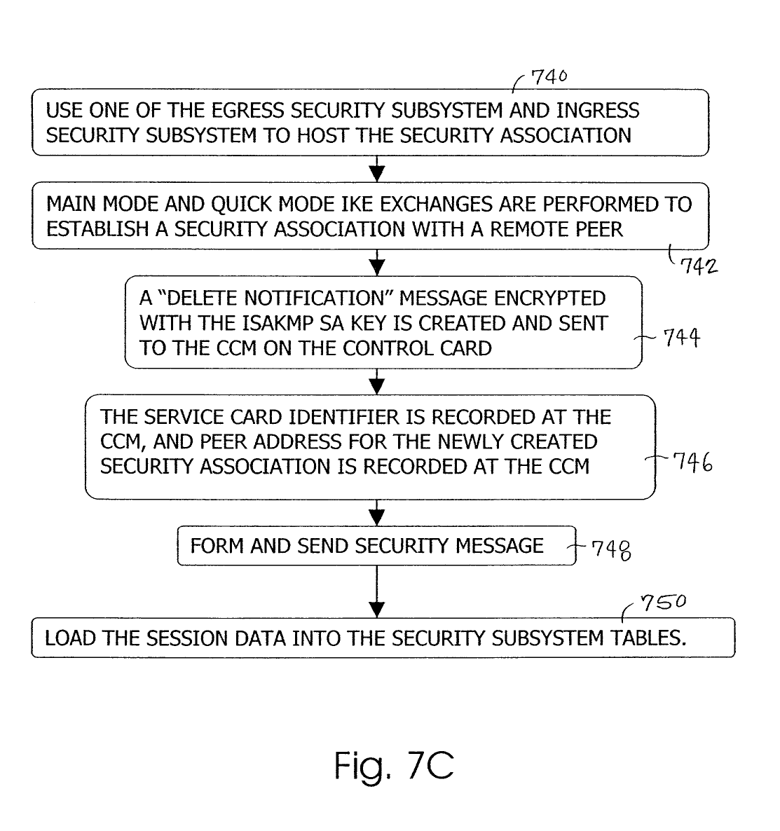

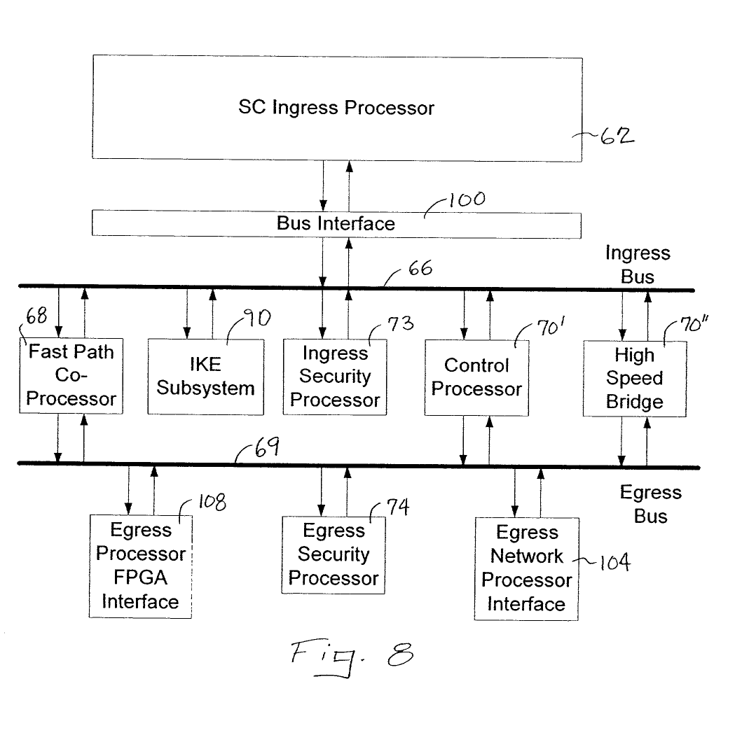

The steps involved in establishing an SA, as the initiator or responder, accessible by both security subsystems in a secure manner are described below and with reference to FIG. 7A. Note that if hardware acceleration is used, these steps can all be performed within the hardware device. Thus, the keying material is never available outside the hardware accelerator in plain text. In what follows, the Secure Hash Algorithm (SHA1, see FIPS-180, “Secure Hash Standard”) is used for generating an authentication value, however any cryptographic hash function that produces a message digest can be used.

1. Upon startup of the device, the two security associations (of each of the security subsystems) establish a shared secret key to be used for symmetric block encryption as shown at 700. For instance, a Diffie-Helman Key Exchange can be used.

2. On the Service Card initiating the IPSec session, either the ingress or egress security subsystem is selected to host the security association as shown at 702. For the alternate embodiment described below, the IPSec subsystem hosts the SA.

3. The Main Mode and Quick Mode IKE exchanges are performed to establish a Security Association with a remote peer as shown at 704.

4. A “delete notification” message encrypted with the ISAKMP SA key is created and sent to the CCM 86 on the control card 36 at 706.

5. The Service Card identifier is recorded at the CCM 86, and peer address for the newly created security association is recorded at the CCM 86 as indicated at 708.

6. Using a shared secret key created in Step 1 (700) the following Session Data (SD) (all values are concatenated) are key, encrypted at 710 using a symmetric block cipher (i.e., 3DES), this includes but is not limited to:

a. SA_SPI

b. SA_SPI_Type (AH_Transport, AH_Tunnel, ESP_Transport, ESP_Tunnel)

c. SA_MAC_Algorithm (SHAL, MD5)

d. SA_MAC_Key_Value

e. SA_Encrypt_Algorithm (DES,3DES)

f. SA_Encryp_Mode (ECB,CBC)

g. SA_Encrypt_Key_Value

7. The following security message (SM) is formed at 712 to send to the other security subsystem:

a. If an initialization vector (IV) is required by the symmetric block cipher, prepend the Initialization Vector (8 bytes) to the encrypted Session Data, i.e., form SM=(IV∥SD) where ∥ denotes concatenation.

b. Calculate a SHA1 hash H_s over SM; i.e., H_s=SHA1 (SM).

c. Append SHA1 Hash to the Security Message, that is, form SM=(SM∥H_s).

8. The SM is sent to the other security subsystem as shown at 712.

9. Upon receipt of the SM, the recipient removes the value H_s from SM; i.e., SM=SM−H_s.

10. The recipient authenticates at 714 by calculating a SHA1 hash over SM; i.e., H_r=SHA1 (SM).

11. If calculated hash H_r does not equal H_S (H_r<>H_s) then

a. Report an SA Authentication error to the sending subsystem.

b. Format a ‘delete notification’ with the sending subsystem, and encrypt it with the ISAKMP SA key and sends it to the remote peer.

c. Use the sending subsystem to direct the CCM to remove the ‘delete notification’.

Otherwise, proceed to Step 12.

12. The SM is decrypted at 716 by the recipient using the shared secret key of Step 1. The decrypted Session Data is then loaded into the security subsystem tables.

Establishing a Distributed Security Association—Method 2

If hardware devices cannot directly support Method 1 in its entirety, the following alternative can be used as described and with reference to FIG. 7B.

1. On the Service Card initiating the IPSec session at 720, either the ingress or egress security subsystem is selected to host the Security Association. For the alternate embodiment described below, the IPSec subsystem hosts the SA.

2. The Main Mode and Quick Mode IKE exchanges are performed to establish a Security Association with a remote peer at 722.

3. A “delete notification” message encrypted with the ISAKMP SA key is created and sent to the CCM 86 on the Control Card 36 at 724.

4. The Service Card identifier is recorded at the CCM 86, and peer address for the newly created security association is recorded at the CCM 86 as shown at 726.

5. The Session Data is extracted, this includes but is not limited to:

a. SA_SPI

b. SA_SPI_Type (AH_Transport, AH_Tunnel, ESP_Transport, ESP_Tunnel)

c. SA_MAC_Algorithm (SHA1, MD5)

d. SA_MAC_Key_Value

e. SA_Encrypt_Algorithm (DES,3DES)

f. SA_Encrypt_Mode (ECB,CBC)

g. SA Encrypt_Key_Value and concatenate all values forming a Session Data (SD) message.

6. The following security message (SM) is formed at step 728 to send to the other security subsystem:

a. Calculate a SHA1 hash H_s over SM; i.e., H_S=SHA1(SM).

b. Append SHA1 Hash to the Security Message, that is, form SM=(SM∥H_s).

7. The SM is sent to the other security subsystem.

8. Upon receipt of the SM, the recipient removes the value H_s from SM; i.e., SM=SM−H_s.

9. The recipient authenticates at 730 by calculating a SHA1 hash over SM; i.e., H_r=SHA1(SM).

10. If calculated hash H_r does not equal H_S (H_r<>H_s) then

a. An SA Authentication error is reported to the sending subsystem.

b. The sending subsystem then formats a ‘delete notification’, encrypts it with the ISAKMP SA key and sends it to the remote peer.

c. The sending subsystem directs CCM to remove the ‘delete notification’. Otherwise, proceed to Step 11.

12. The Session Data is then loaded into the security subsystem tables at 732.

Establishing a Distributed Security Association—Method 3

In a high-speed network device the overhead associated with either Method 1 or Method 2 may inflict a performance penalty. The IPSec architecture allows for manual configuration of security associations. Therefore, the following alternative can be used, described with reference to FIG. 7C.

1. On the Service Card initiating the IPSec session, either the ingress or egress security subsystem is selected to host the Security Association at step 740. For the alternate embodiment described below, the IPSec subsystem hosts the SA.

2. The Main Mode and Quick Mode IKE exchanges are performed to establish a Security Association with a remote peer at 742.

3. A “delete notification” message encrypted with the ISAKMP SA key is created and sent to the CCM 86 on the Control Card 36 at 744.

4. The Service Card identifier is recorded at the CCM, and peer address for the newly created security association is recorded at the CCM 86 at 746.

5. The Session Data is extracted, this includes but is not limited to:

a. SA_SPI

b. SA_SPI_Type (AH_Transport, AH_Tunnel, ESP_Transport, ESP_Tunnel)

c. SA_MAC_Algorithm (SHA1, MD5)

d. SA_MAC_Key_Value

e. SA_Encrypt_Algorithm (DES,3DES)

f. SA_Encrypt_Mode (ECB,CBC)

g. SA_Encrypt_Key_Value and concatenate all values forming a Session Data (SD) message.

6. The formed SM is sent to the other security subsystem as indicated at 748.

7. A security association is created manually by the receiving security subsystem. The receiving security subsystem populates the SA with data in the received security message at 750.

According to any of the exchange methods, when the SC ingress processor 62 receives a data packet whose protocol type indicates that it has undergone IPSec treatment (encryption), the packet is immediately transferred to the ingress security processor 74 for decryption. Decryption results in an IP packet. This IP packet is then sent back to the SC ingress processor 62. When the SC ingress processor receives this packet, the security policy of this packet is again checked using the 5-tuple (Source Address, Source Port, Destination Address, Destination Port, Protocol Type). Three cases then exist: (1) the policy lookup indicates that the packet should not have arrived with IPSec treatment so that the IP packet is dropped; (2) the packet should have arrived with IPSec treatment and so it is passed on for further protocol processing on this SC 24 (which may include IPSec treatment on egress); (3) the packet is yet another IPSec packet and the security processing begins anew. When egress processing has ended, the packet is transferred to the SC egress processor 64 via the egress bus 69 and the egress processor FPGA Interface 108.

If the SC ingress processor 62 receives a packet and the policy lookup indicates this packet requires IPSec treatment on egress and an SA with the designated remote peer exists, the packet is immediately transferred to the egress security processor 74 via the high speed bridge 70″. After security processing, the resulting packet is transferred to the SC egress processor 64 via the egress bus 69 and egress processor FPGA interface 108 for further protocol processing or to the SC egress network processor via the egress bus 69 and egress network processor interface 104.

FIG. 8 shows an alternative embodiment with a separate IKE subsystem 90 dedicated to performing key exchanges and to distribute the security associations to the ingress and egress security processors 62 and 64. In applications involving high demand for security with frequent rekeying, this architecture is advantageous as it uses a security processor 73 (or 74) for cryptographic support and uses the IKE processor(microprocessor) 112 for generating and maintaining the IKE protocol state. When the IKE protocol terminates, the resulting SA's are transferred by from IKE processor 90 to the ingress and egress security processors 73 and 74. The distribution procedure may be followed as in one of the three examples above. The IKE subsystem 90 handles IKE in a dedicated fashion. The software is hosted on the fast path coprocessor 68. The IKE subsystem runs the algorithms and math for the key exchange only. The IKE subsystem 90 then distributes the SA's.

The invention provides a device based on modular units. The term card is used to denote such a modular unit. The modules may be added and subtracted and combined with identical redundant modules. However, the principals of this invention may be practiced with a single unit (without modules) or with features of modules described herein combined with other features in different functional groups.

While specific embodiments of the invention have been shown and described in detail to illustrate the application of the principles of the invention, it will be understood that the invention may be embodied otherwise without departing from such principles.

What is claimed is:

1. A network gateway device comprising:
a network physical interface for receiving and transmitting data and for receiving packets for transmission and forwarding packets from received data; and
a packet processor hosting a security association (SA) used for encryption and decryption for communication with a network peer and including:
an ingress processing security subsystem with a decryption processor for decrypting packets; and
an egress processing security subsystem for encrypting packets, one or both of said ingress processing security subsystem and said egress processing security subsystem receiving one or both of ingress and egress SAs.

2. A network gateway device according to claim 1, wherein said packet processor includes a processor subsystem for handling key exchanges and for distributing SAs to the ingress processing security subsystem and said egress processing security subsystem.

3. A network gateway device according to claim 1, wherein said ingress processing security subsystem and said egress processing security subsystem hosts a security association (SA) used for encryption and decryption for communication with a network peer and one of said ingress processing security subsystem and said egress processing security subsystem distributing at least one of ingress and egress SAs to the other of said ingress processing security subsystem and said egress processing security subsystem.

4. A network gateway device according to claim 1, wherein said packet processor includes an ingress processor system for ingress processing of received packets and an egress processor system for processing packets for transmission, said ingress processor system including an ingress packet processor and including said ingress processing security subsystem, said egress processor system including an egress packet processor and including said egress processing security subsystem and interconnections including an interconnection between said ingress processor and said egress processor, an interconnection between said ingress processor and said physical interface and an interconnection between said ingress processor and said physical interface.

5. A network gateway device according to claim 4, wherein said ingress processing security subsystem includes memory and a hardware accelerator for running decryption algorithms, said ingress processing security subsystem includes memory and a hardware accelerator for running decryption algorithms.

6. A network gateway device according to claim 4, further comprising a packet queue establishing a queue of packets awaiting transmission, said packet queue being the exclusive buffer for packets between packets entering the device and packet transmission.

7. A network gateway device according to claim 6, wherein packets exit the device at a rate of the line established at the physical interface.

8. A network gateway device according to claim 4, wherein said ingress processing system processes packets including at least one or more of protocol translation, de-encapsulation, decryption, authentication, point-to-point protocol (PPP) termination and network address translation (NAT) and said egress processing system processes packets including at least one or more of protocol translation, encapsulation, encryption, generation of authentication data, PPP generation and NAT.

9. A network gateway device according to claim 4, wherein said ingress processor system includes a fast path processor subsystem processing packets at speeds greater than or equal to the rate at which they enter the device.

10. A network gateway device according to claim 9, wherein said fast path processor system provides protocol translation processing converting packets from one protocol to another protocol.

11. A network gateway device according to claim 9, wherein said egress processor system includes a fast path processor subsystem processing packets at speeds greater than or equal to the rate at which they are to leave the device.

12. A network device according to claim 9, wherein said ingress processor system includes a fast path co-processor for additional packet processing concurrently with fast path processor packet processing, said fast path co-processor processing packets including one or more of network address translation (NAT) processing and NAT processing coupled with application layer processing (NAT-ALG).

13. A network device according to claim 9, wherein said ingress processor system includes a control packet processor for additional packet processing concurrently with fast path processor packet processing, including processing packets signaling the start and end of data sessions, packets used to convey information to a particular protocol and packets dependent on interaction with external entities.

14. A network device according to claim 4, wherein said physical interface includes a line card and said ingress processor system is provided as part of a service card and said egress processor system is provided in one of said service card and another service card and said interconnections include:
a line card bus connected to said line card;
a service card bus connected to at least one of said service card and said another service card; and
a switch fabric connecting said line card to at least one of said service card and said another service card.

15. A network device according to claim 14, wherein said service card includes said ingress processor system and said egress processor system and said another service card includes another ingress processor system for processing all or part of packets received from said line card and for sending ingress processed packets for egress processing and another egress processor system for receiving ingress processed packets and for processing all or part of received packets for sending to said line card, whereby packets may be sent between service cards for ingress processing by one service card and egress processing by another service card or for ingress processing using more than one service card.

16. A network gateway device according to claim 15, wherein each of said service cards is identical and a spare service cards is provided, for functionally replacing any one of the other service cards to provide redundancy.

17. A network gateway device according to claim 15, wherein said physical interface includes another line card connected by said switch fabric to at least one of said service card and said another service card.

18. A network gateway device according to claim 17, wherein said switch fabric connects any one of said line cards to any one of said service cards, whereby any line card can send packet traffic to any service card and routing of packet traffic is configured one of statically and dynamically by the said line card.

19. A network gateway device according to claim 15, wherein:
said service card bus includes a static bus part for connection of one of said service cards through said switch fabric to one of said line cards and a dynamic bus for connecting a service card to another service card through said fabric card allowing any service card to send packet traffic requiring ingress processing to any other service card for ingress processing and allowing any service card to send traffic requiring egress processing to any other service card for egress processing, whereby the system can make use of unused capacity that may exist on other service cards.

20. A process for secure communication between network entities, the process comprising the steps of:
providing a device with a network interface and physical connection with a packet processing system including an ingress processing subsystem and an egress processing subsystem;
making a key exchange between the network entity and the other network entity and hosting a security association upon completion of the key exchange in association with a processing entity of the packet processing system, the security association including information as to authentication, encryption and changing of keys;
extracting data derived from the security association;
sending a message from a processing entity hosting the security association to one or both of said ingress processing subsystem and said egress processing subsystem to provide a security association at the processing subsystems.

21. A process according to claim 20, wherein said packet processor includes an ingress processing security subsystem and an egress processing security subsystem and a processor subsystem for handling key exchanges and for distributing SAs to the ingress processing security subsystem and said egress processing security subsystem.

22. A process according to claim 20, wherein said packet processor includes an ingress processing security subsystem and an egress processing security subsystem, one of said ingress processing security subsystem and said egress processing security subsystem hosting the security association used for encryption and decryption for communication with a network peer said one of said ingress processing security subsystem and said egress processing security subsystem distributing at least one of ingress and egress SAs to the other of said ingress processing security subsystem and said egress processing security subsystem as a security message.

23. A process according to claim 22, further comprising:
selecting either the ingress processing subsystem or the egress processing subsystem to host a security association.

24. A process according to claim 22, wherein said security message includes authentication features for authenticating the transmission of said session data.

25. The process according to claim 22, further comprising the steps of establishing a shared secret key at each of the ingress processor and egress processor for use for symmetric block encryption; and encrypting said session data using the symmetric block encryption cipher.
